(19) United States
(12) Patent Application Publication
(10) Pub. No.: US 2019/0250268 A1
(43) Pub. Date: Aug. 15, 2019

(54) ENHANCED TERMINAL SURVEILLANCE SERVICES FOR SPECTRUM EFFICIENT NATIONAL SURVEILLANCE RADAR (SENSR) APPLICATIONS

(71) Applicant: Intersoft Electronics, Inc., McLean, VA (US)

(72) Inventor: Alexander E. Smith, McLean, VA (US)

(21) Appl. No.: 16/273,385

(22) Filed: Feb. 12, 2019

Related U.S. Application Data
(60) Provisional application No. 62/629,265, filed on Feb. 12, 2018.

(51) Int. Cl. G01S 13/91; G01S 7/28; G01S 7/282

(52) U.S. Cl. CPC G01S 13/91; G01S 7/282; G01S 7/2813

(57) ABSTRACT

A system and method of enhancing radar functionality in a geographical region. In one or more terminal radar systems, the existing radar transmitter is upgraded with an improved transmitter having a higher efficiency, the existing radar receiver is upgraded with an improved receiver having a higher sensitivity, and the existing processor with is improved or modified to perform new functions including the acquisition of additional surveillance data, extended surveillance range and improved target resolution. The new functionality enables the selected terminal to provide long range, 3-D en route radar data, including height information, while continuing to provide short-range, 2-D surveillance data. The new functionality may also include the ability to register radar surveillance against either true or magnetic north; provide a 3-D primary radar picture to augment Wide Area Multilateration (WAMLAT); to serve as a 3-D truth source or back up service to augment Automatic Dependent Surveillance (ADS-B); and/or provide a regional, real-time drone map.

### REFERENCE TO RELATED APPLICATIONS

This invention application claims priority to, and the benefit of, U.S. Provisional Patent Application Ser. No. 62/629,265, filed Feb. 12, 2018, the entire content of which is incorporated herein by reference.

### FIELD OF THE INVENTION

This invention relates generally to aircraft terminal surveillance and, more particularly, to a method and system that improves the functionality of existing terminal radar systems and provides additional surveillance data, including extended range and improved target resolution.

### BACKGROUND OF THE INVENTION

In the Spectrum Efficient National Surveillance Radar (SENSR) Concept of Operations, Version 1.0 Jan. 3, 2017, by DoT/FAA, DoD, DHS, and DoC/NOAA, incorporated herein by reference, a future surveillance architecture is envisaged for the United States. That concept embraces a holistic view of surveillance, one that is extensive, seamless, and multi-function, i.e., civil, military and other security functions.

One of the major challenges is the transition from today's aging, distributed, non-integrated radar network to a new comprehensive, fully integrated, multi-user system. On top of that, many agencies are forced to address urgent maintenance and upgrade issues today, just a few years ahead of the SENSR panacea, which envisions a commencement in the early 2020s.

### Existing Radar Systems

The SENSR Concept of Operations lists all current FAA radar facilities, shown in FIGS. 1 through 4 (for Air Traffic Control, weather radars are not shown here). FIG. 1 portrays the long-range surveillance network coverage in the United States, which is a 3-dimensional coverage (i.e., includes height) at over 200 nautical miles with an update rate of approximately 12 seconds based on the radar rotation rate. FIGS. 2 through 4 show terminal coverage (2-D), which is lower coverage out to 60 nautical miles, at a higher update rate (˜4.7 seconds). The different radars are ASR-8, ASR-9, and ASR-11, which all essentially provide the same function, where the numbering indicates age, ranging from approximately 40 years for the ASR-8 to 20 years for the newer ASR-11. All of these radar systems, however, are now operating beyond their design life and are in the process of being upgraded or considered for upgrade, as it is not expected they will currently be able to provide service until the deployment of the new SENSR program.

### Radar Receiver and Processor System Upgrades

As of 2018, the FAA is considering upgrading most of its terminal radar system inventory, including the ASR-8 and the ASR-9, with a looming decision concerning the ASR-11. ASR-8 upgrades are underway as specified in FAA's Common Terminal Digitizer program, as documented in: Statement of Work for Common Terminal Digitizer (CTD), Revision 1.0, 15 Nov. 2013, Federal Aviation Administration, DTFAWA-13-R-00018, incorporated herein by reference.

With that ASR-8 radar upgrade, the main intention was to digitize the older style analog output; however, the upgrade supplied by the company Intersoft Electronics provided many additional features by way of its newer design. For the most part, these newer features are a product of the new signal processing known as the Next Generation Signal Processor (NGSP) as described in: Service Life Extension Programs and Radar Upgrades Catalog: Intersoft Electronics NV, Head Office, Lammerdries-Oost 27, 2250 Olen, Belgium, incorporated herein by reference. (http://www.intersoft-electronics.com/Downloads/Radar%20Upgrades/Product%20Catalogue/IE-CD-00109-007%20SLEPS-Radar%20Upgrades%20HR.pdf)

Specifically, new signal processing offers major improvements over the previous industry standards, including higher processing gain and 3-D functionality, each of which is described in U.S. Pat. No. 8,599,060, Clutter Reduction in Detection Systems, incorporated herein by reference.

### Radar Transmitter Upgrades

In 2018, with the FAA upgrading the signal processing and receiver aspects of older systems under the auspices of the Common Digitizer program, described above, the opportunity now exists to upgrade radar transmitters. The transmitters currently employed in the ASR-8 and ASR-9 use line type modulators for pulse forming and Klystron transmitters as shown in FIGS. 5, 6 and 7. The Klystron-based transmitters in these radar systems are based on 30- to 40-year-old technology, and that FAA has considered upgrading to solid-state versions on many occasions.

These older units are known as line type for the transmission line properties of the pulse forming network. More than forty years after the introduction of this type of technology, many operators, including FAA are struggling with obsolescence, maintainability and cost of ownership. In evaluating the cost of maintaining these older systems today, Brown, P. D., Casey, J. A. Mulvaney, J. M., Hawkey, T. A., Kempkes, M. A., Gaudreau, M. P. J., Improvements in Radar Transmitter Performance and Reliability Using High-Voltage Solid-State Modulators and Power Supplies. Presented at the 2002 IEEE International Radar Conference, April 2002, incorporated herein by reference, states:

“Transmitters fielded for multiple decades are costly because the traditional modulator vendor base is disappearing. Conventional high-power, high-voltage modulator expertise has diminished, as have the vendors that supported them; exemplified by recent shifts in source and availability of vacuum switch tubes. Cost-effective radar transmitter maintenance has now become the hazardous occupation.”

### Early Solid State Transmitters

In 1994, FAA evaluated a solid-state transmitter upgrade for the ASR-9 at the FAA Technical Center. In his analysis of that candidate upgrade, Ferranti, R. L., Solid State Radar Demonstration Test Results at the FAA Technical Center, 17 Jun. 1994. Project Report ATC-221, Lincoln Laboratory, incorporated herein by reference, stated:

“Though solid state radar has been used in military applications for many years, transistor power amplifiers capable of operating in the 2.9 GHz Air Traffic Control radar band have only recently become available. Solid state radar transmitters offer the potential for increased reliability and maintainability, and do not require the hazardous high voltages necessary for electron devices like klystrons. However, solid state transmitters cannot produce the high peak powers available from vacuum tubes and use long coded pulses to obtain adequate detection performance.”

While the Klystron transmitters had peak power in the megawatts (1.1 MW for the ASR-9), 1990's contemporary replacement solid state devices were in the tens of kW (˜20 kW for the ASR-9 FAA Technical Center trial in 1994 and for the newer ASR-11 solid-state transmitter). (FIG. 8). Peak powers significantly lower than those used by Klystron techniques were possible with solid state to achieve performance at range due to the introduction of pulse compression techniques: the combination of short and long pulses to operate throughout the coverage volume. Essentially, pulse compression used modulation of the transmission pulse and correlation of the received signal with the transmitted pulse. Ferranti did go on to explain that the 1990's-era 20 kW solid-state transmitter, developed by ITT-Gilfillan and Thomson-CSF, had a few shortcomings, but overall had excellent stability and adequate detection performance (using pulse compression) at the short-pulse long-pulse transition range. (See FIG. 9).

### Gallium Nitride Solid State Transmitter Developments

Much has happened in S-band power amplifier development over the past twenty years, not least of which is the virtual explosion of the mobile phone industry. The latest, most prevalent technology used for power amplification in mobile phone bands as well as civil radar bands is now Gallium Nitride (GaN). According to Flaherty, N., Top Four Companies Dominate as GaN Market Booms. EENews Europe Power Management, Sep. 5, 2016, incorporated herein by reference, “In the past few years, GaN technology has witnessed rapid advancements and vast improvement in the ability of GaN semiconductors to work under operating environments featuring high frequency, power density, and temperature with improved linearity and efficiency, driving the growth.” (Flaherty, 2016).

In testing a GaN 1 kW module for S-band radar applications, Ju-Young Kwack, J. Y., Kim, K. W., Cho, S., 1 kW S-band Solid State Radar Amplifier. Wireless and Microwave Technology Conference (WAMICON), 2011 IEEE 12th Annual Conference, incorporated by reference, found that the unit delivered over 1 kW across a 400 MHz bandwidth with a 55 dB gain and increased (power-added) efficiency of 34% (FIG. 10). These modules may be combined in various ways in order to achieve higher desired power outputs, depending on the requirements of the application.

Generally, over the past several years, the aerospace industry has embraced GaN for radar solutions, for example, Hensoldt with its ASR-NG radar, employing over 20 kW to achieve ranges of 120 nm (Hensoldt, 2017), and Thales with its defense radars and the STAR NG radar, using 15 kW for terminal applications (ATM, 2015). Intersoft, also has fielded several radar upgrades using GaN-based power amplifiers, although the company has managed to use significantly more efficient receiver-transmitter designs that operate effectively with lower peak power levels as discussed below.

### Intersoft GaN-Based Radar Transmitter Designs

As a design principle, Intersoft Electronics strives for efficiency: how to most effectively make use of the elements and constraints of existing radar systems through intelligent design. One such goal is to lower the transmission power necessary for terminal radar systems, in part to simplify design but also to extend the life cycle of major system components such as splitters, combiners and filters. For example, based on extensive field experience, power amplifiers using over 15 kW or so continue to be responsible for many failures and push the operation of rotary joints to the limit, driving maintenance costs and procedures. Operating with lower power has additional benefits for system dynamic range and is more environmental friendly, not only for neighboring radars but for the entire telecom industry.

### FAA Coverage and Power Requirements

The Federal Aviation Administration, 1 Oct. 1986 FAA Specification, Airport Surveillance Radar ASR-9, FAA-E-2704B, incorporated herein by reference, lays out the requirements in the original ASR-9 specification as follows:
“detection of a target of one square meter radar cross section with a probability of detection of 0.8 at a range of 55 nautical miles inbound and outbound. The target is assumed to be at the nose of the low-beam radiation pattern; the radar is assumed to be operating in linear polarization with the antenna mounted atop a 47-foot tower. Swerling Case 1 target fluctuation and 10⁻⁶ false alarm probability shall be assumed.” (Section 3.4.2).
“The normal operating peak output power shall be that level required to provide the coverage requirements of paragraph 3.4.2.” (Section 3.10.2).

And for the altitude, requirements are as follows:
“The contractor shall demonstrate that the system coverage requirements as outlined in paragraph 3.4.2 are met or exceeded. Tests shall include at least ten scheduled radial flight tests (five inbound, five outbound) extending between 30 nm and 60 nm in range from each test site . . . Detection performance referred to the standard one square meter (1 m²) target shall equal or exceed the requirements of paragraph 3.4.2 . . . Once the peak of beam is determined for a 1 m² target, the contractor shall develop a Radar Cross Section (RCS) detection capability for the entire lobe for a 1 m² target. This shall cover −0.5° to +60°.” (Section 4.3.3).
“The contractor shall demonstrate the range capability of the ASR for a 1 m² target, Pd 0.8, LP, and 10⁻⁶ false alarm probability in the clear. Tests shall be conducted in increments of 1,000 feet up to 10,000 above site elevation, and at 15K and 20K above site elevation. The antenna shall be aligned to set the nose of the beam at +2° . . . Detection performance shall be related to test results using radar cross-section data approved by the Government for the flight check aircraft. These results shall be converted to indicate the expected coverage for a 1 m² target.” (Section 4.3.4).

In summary, these requirements may be interpreted (at a high level for the purposes of this assessment) as Pd≥0.8, RCS 1 m², out to 55 nm and from −0.5° to +60°, for flight levels up to 20 kft. Furthermore, although the ASR-9 specification anticipated a contemporary power amplifier solution, which at the time was a Klystron with a peak power in excess of 1 MW, the FAA expected that the peak power setting be adjusted down to the minimum to achieve these coverage requirements.

### Surveillance Monitoring Systems

One of the issues with an upgraded radar that provides extra information (such as 3-D) is that the existing automation system may not be designed to accommodate it, and therefore an alternative means of using the data is required. One such method is to use an alternative, additional radar data monitoring service such as the Surveillance Monitoring System (SMS). Current FAA radar data communications use predominantly serial interfaces, although the agency has considered moving to IP based systems such as the Surveillance Interface Modernization (SIM) program shown in FIG. 11.

The FAA has been considering various upgrades to its radar system monitoring and control capabilities, not least of all, a possible broad conversion to IP protocols and cloud hosting for macro performance analyses. While laudable, some of these programs have stalled in the FAA, including the SIM program due to funding issues. However, there are commercial products available that can be used to output radar data using Internet Protocol, such as Intersoft Electronics' Surveillance Monitoring System (SMS). Intersoft's SMS is now being used successfully, or planned to be used to monitor on the order of 100 different OEM sensors or so worldwide, including PSR, SSR, ADS-B, ASDE, multilateration, and surface movement radars, at sites including Singapore, Australia, Indonesia, Cyprus, Hungary, Serbia and Malaysia.

### SUMMARY OF THE INVENTION

Central to the theme of the approach outlined herein in is the innovative use of upgrades to current terminal radar systems, to fulfill present-day missions but also to provide new services that dovetail directly into future SENSR requirements. These innovative upgrades meet current needs to address obsolescence and maintainability, but also provide future SENSR functionality, easing the transition to a new surveillance system, and in some ways actually providing part of the SENSR functionality through the novel use of upgraded existing infrastructure.

The method and system described herein improves the functionality of existing terminal radar systems, providing additional surveillance data, including extended range and improved target resolution. Use of a combination of improved receiver, processing, and transmitter techniques allows a radar's range to be extended and provides novel information such as 3-D target data (height), previously only available with long range military-grade radar systems.

The invention provides a system and method of enhancing radar functionality in a geographical region wherein a plurality of existing terminal radar systems provide limited area surveillance. In accordance with a method aspect of the invention, one or more of the terminal radar systems are selected, each having an existing radar transmitter, radar receiver and processor that together provide only short-range, 2-D radar surveillance. The existing radar transmitter is upgraded with an improved transmitter having a higher efficiency, the existing radar receiver is upgraded with an improved receiver having a higher sensitivity, and the existing processor with is improved or modified to perform a new functions based upon the higher sensitivity and higher sensitivity. These new functions include the acquisition of additional surveillance data, extended surveillance range and improved target resolution, while the selected terminal radar system continues to provide short-range, 2-D surveillance.

Note that, as used herein, “upgraded” should be taken to mean improving or modifying existing equipment with one or more of the advancements disclosed herein as opposed to replacing the equipment with entirely new equipment. While replacement with new equipment is not precluded by the invention, improving or modifying existing equipment is preferred, as one of the tenets of the invention is to provide advanced functionality before entirely new equipment even becomes available.

In a preferred embodiment, the new functions enable the selected terminal to provide long range, 3-D en route radar data, including height information, while continuing to provide short-range, 2-D surveillance data. The 3-D data may be virtual 3-D data synthesized from the 2-D surveillance data, used to track targets with extended ranges in 3-D. Desirably, the upgraded terminal radar systems may meet at least some Spectrum Efficient National Surveillance Radar (SENSR) requirements.

The new functionality may also include the ability to register radar surveillance against either true or magnetic north; provide a 3-D primary radar picture to augment Wide Area Multilateration (WAMLAT); to serve as a 3-D truth source or back up service to augment Automatic Dependent Surveillance (ADS-B); and/or provide a regional, real-time drone map.

The new information made possible by this invention may then be integrated into a variety of novel applications, including virtual replacement of long range radar on a macro level, with improved terminal radar functionality, as well as serving as homogenous regional networks for small drone tracking services, which is currently unavailable from existing radar implementations

### BRIEF DESCRIPTION OF THE DRAWINGS

FIG. 1 is a diagram that illustrates existing U.S. Long Range Radar Systems;

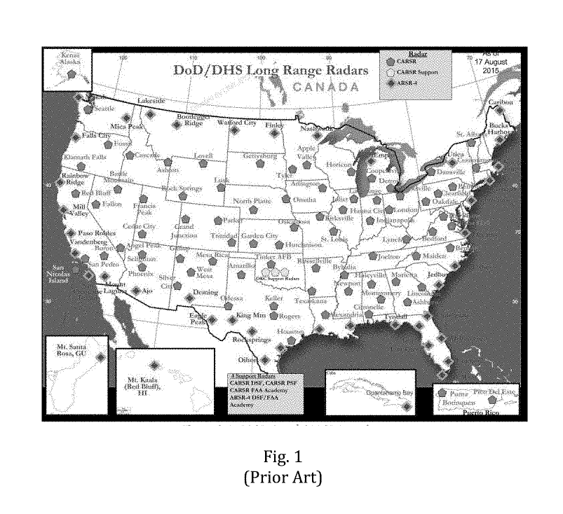

FIG. 2 is a diagram that shows existing ASR-8 Terminal Radar Systems;

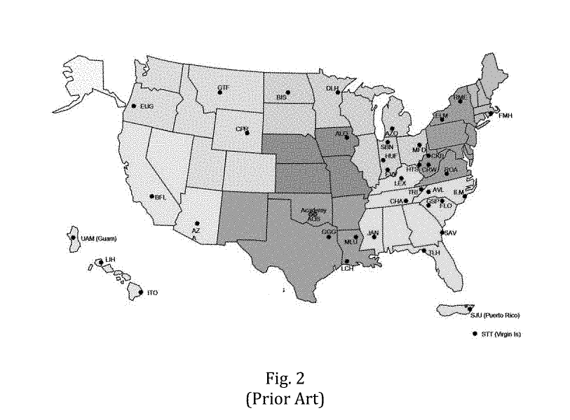

FIG. 3 is a diagram that depicts existing ASR-9 Terminal Radar Systems;

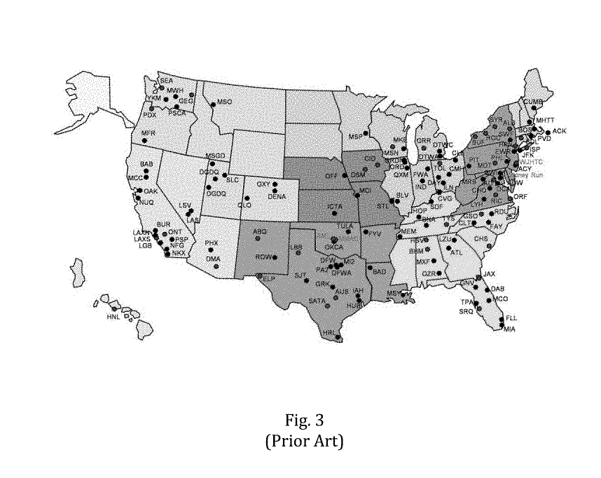

FIG. 4 is a diagram that illustrates existing ASR-11 Terminal Radar Systems;

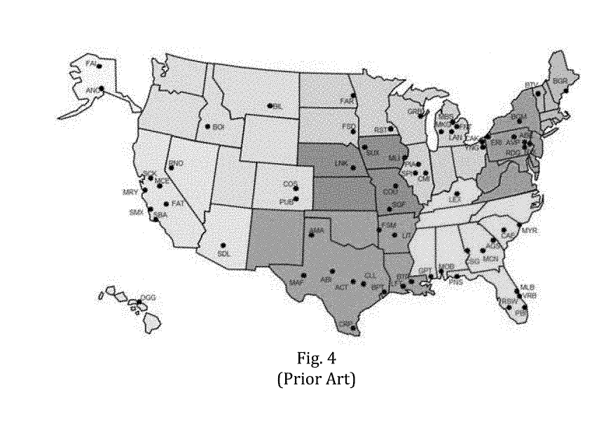

FIG. 5 shows a typical ASR Pulse Forming Network (PFN) and Line-Type Modulator (Brown et al. 2002);

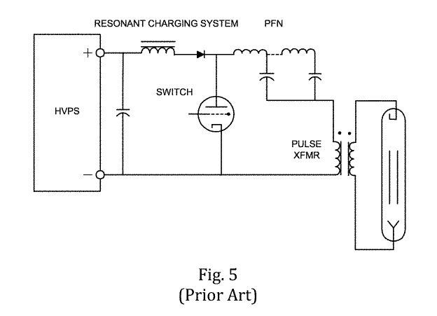

FIG. 6 illustrates ASR-8 Showing Klystron Transmitter and Receiver Cabinets;

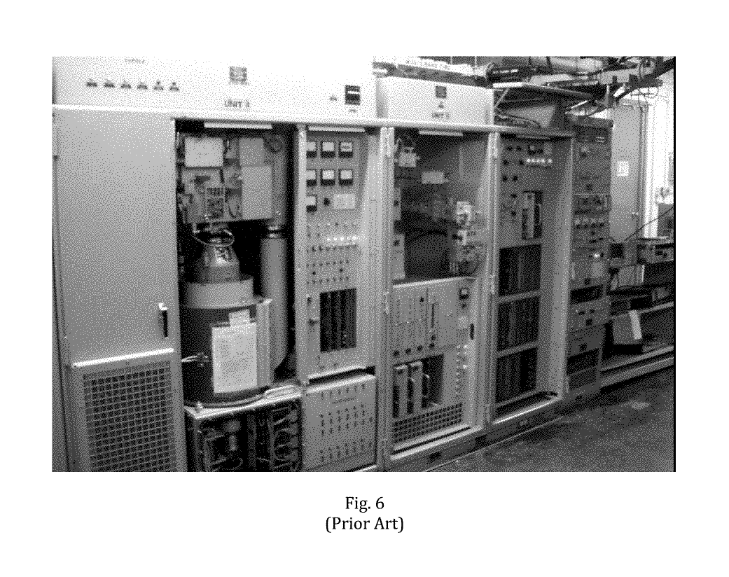

FIG. 7 depicts Tube Transmitter Configurations for Present Day ATC/Weather Radars;

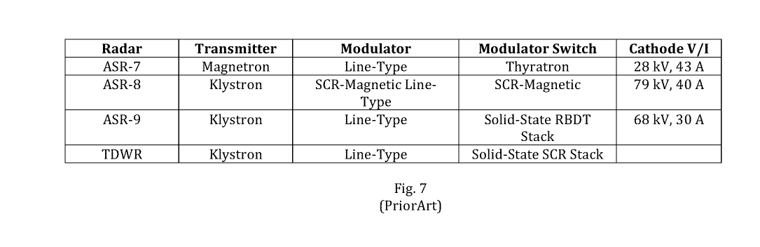

FIG. 8 shows FAA S-Band Radar Transmitter Receiver Combinations;

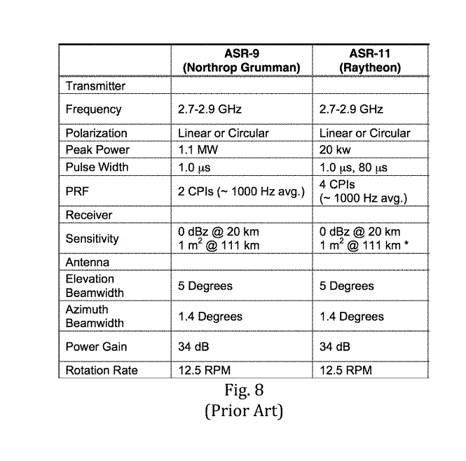

FIG. 9 helps to understand how 1990s Contemporary 20 kW S-Band Solid State Transmitters were an important contribution;

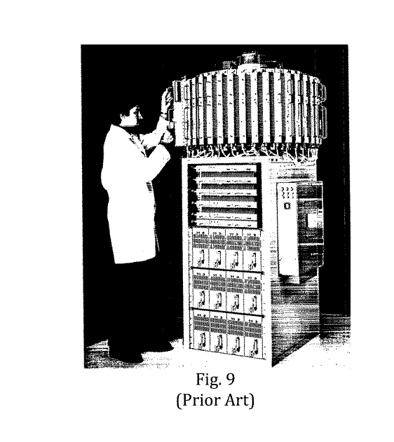

FIG. 10 shows the early version of a Compact 1 KW GaN Module used for S Band Radar;

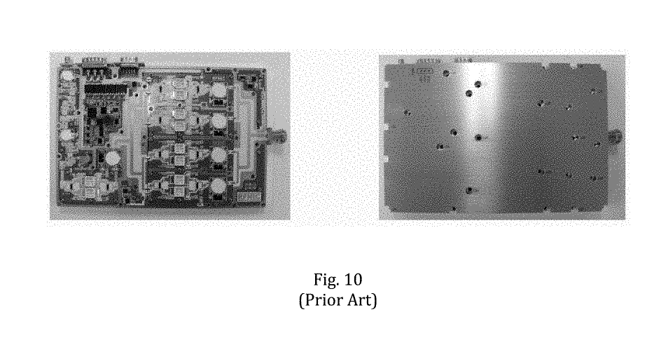

FIG. 11 is a diagram that depicts the FAA's Envisaged Surveillance Interface Modernization Architecture;

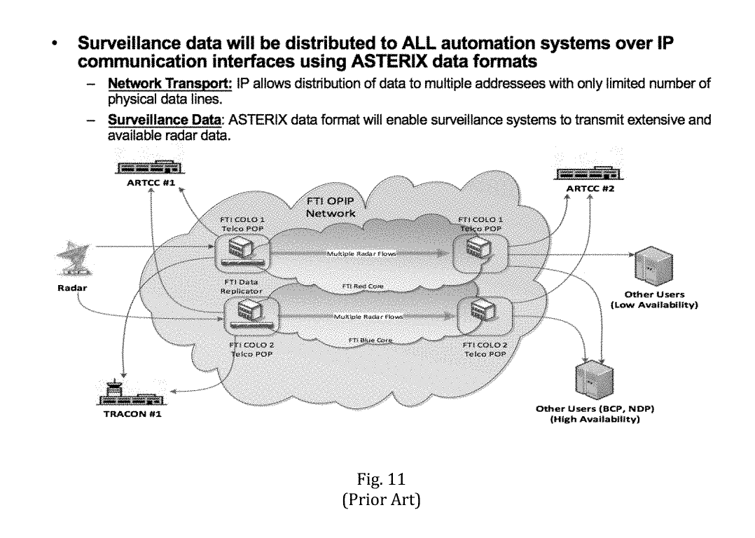

FIG. 12 illustrates the causes of aviation equipment obsolescence (FAA, 2015, prior art); and

FIG. 13 illustrates a preferred embodiment of the invention wherein an existing terminal radar is provided with a new receiver, processor and transmitter upgrade, resulting in performance improvements to receiver sensitivity and transmitter efficiency.

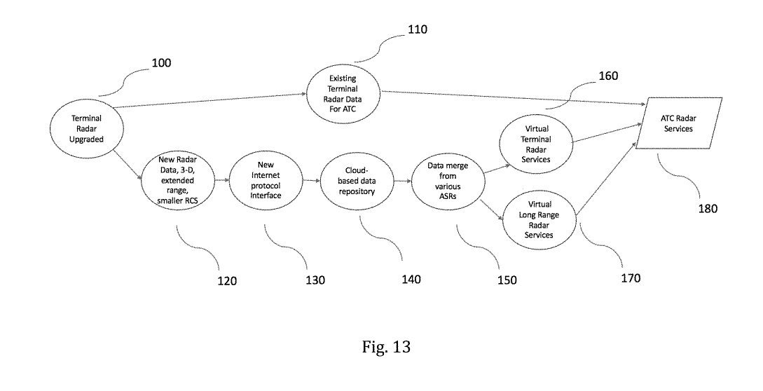

### DETAILED DESCRIPTION OF THE INVENTION

In accordance with this invention, selective improvements are made to existing air traffic control installations to provide entirely new and innovative, previously unforeseen, radar functions. Existing equipment “upgrades” are intended to overcome obsolescence—that is, to keep existing equipment running longer, and past prescribed life cycles, while performing the same functions. In the context of this invention, these “upgrades,” as requested and delivered to existing radar users, are intended to improve and sustain the equipment's operation over a longer life cycle on a status quo basis. In contrast, in accordance with this invention, while equipment may be upgraded for longevity, these improvements also achieve new functionality, thereby bridging the gap between existing stop-gap measures and real performance enhancements requiring comprehensive modernization.

### Existing Air Traffic Equipment “Upgrades”

Most types of technical systems undergo upgrades as general technology improves. Examples from the computer industry may include a steady expansion of availability in storage or memory, and significant increases in the speed of processing. These types of upgrades are pervasive and ongoing within technology-oriented industries, and generally lead to improvements in equipment performance, sustainability and ongoing compatibility.

When it comes to commercial air traffic control systems, or military equivalents, it is becoming more common practice that service providers (mainly governments) use equipment beyond the original anticipated design life cycle of for example, 20 or 25 years. As time extends towards the end of this life cycle, assuming a relatively good maintenance record and ongoing history of equipment operation, governments will opt to extend the operation and support of the equipment for several more years, for example by a further 10 or 15 years.

In these cases, the user, e.g., government or military, may look to industry to compete or propose solutions and give pricing to upgrade equipment for the purposes of sustainability and ongoing maintainability. Note the use of the word “upgrade” used within this general context is really aimed at avoiding equipment obsolescence. Through existing upgrades, equipment maintainability and sustainability may be enhanced, but overall functionality remains the same.

### Current Efforts to Managing Equipment Obsolescence

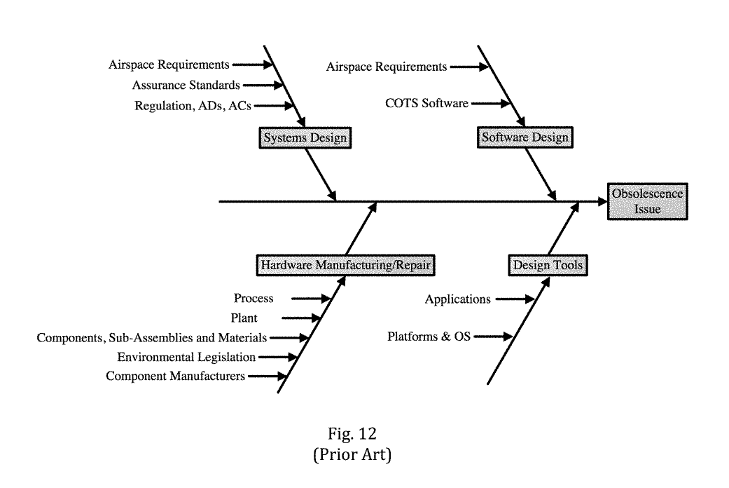

The Federal Aviation Administration (FAA) characterizes the main reasons of aviation equipment obsolescence as “1) supply side, bottom-up supply-chain caused and 2) demand-side, top-down airspace-management and regulation-caused.” (FIG. 12, from Federal Aviation Administration. Obsolescence and Life Cycle Management for Avionics. DOT/FAA/TC-15/33. November 2015, incorporated herein by reference). It has been determined that this obsolescence is mainly due to the ongoing availability and scarcity of components and replacement parts.

The FAA goes on to conclude that the fundamental cause of the supply chain issue is that the aviation industry is not vertically integrated and depends on an extensive commercial off-the-shelf (COTS) supply base, which creates a “technology life-cycle mismatch between the supply base and avionics manufacturing.” The FAA also notes that while component supply chains are a commercially focused technology cycle of approximately two to seven years, the life cycle of aircraft and avionics is typically 20 years or more.

Additionally, according to Federal Aviation Administration. Review of Pending Guidance and Industry Findings on Commercial Off-The-Shelf (COTS) Electronics in Airborne Systems. DOT/FAA/AR-01/41. August 2001, incorporated herein by reference, “obsolescence will persist as a problem for OEMs serving markets that require supported lifetimes of 20 years or more. Commercial market trends will make parts obsolescence even more significant in the future. Alternate methods currently employed to mitigate parts obsolescence are all very costly. It remains to be seen, if the current COTS trend in military programs can be supported at reasonable cost over the life of the systems.”

Thus, whereas equipment obsolescence is unavoidable, the FAA believes that for projected equipment life cycles of 20 years or so, it is exacerbated by the increasing trend in COTS usage and outsourcing. As recommended by the FAA, minor resolutions to many obsolescence problems include reverse-engineering and PCB redesign or patches to various systems; however, by most accounts this approach is not successful overall, is costly, and really just extends the overall problem of upgrade or replacement.

In accordance with this invention, it has been discovered that through judicious and selective improvements to existing equipment, advanced functionality is possible without wholesale overhaul. As one example, described in more detail below, by picking and choosing equipment upgrades, an existing short range, 2-D terminal radar may behave as a virtual long range, 3-D en route radar, a possibility that is now unheard of in the industry. This improvement in functionality is currently not possible through the mere provision of upgrades to minor systems in the short-range radar. However, in accordance with the invention, while upgrading or replacing parts of the aging terminal radar, elements of the upgraded equipment are exploited to uniquely provide entirely new radar functionality.

This is achieved, in part, by replacing the radar receiver systems with a higher sensitivity radar receiver, replacing the transmitter with a variable, low-to-high power transmitter, employing beam combination to provide 3-D, and uniquely modifying many other parameters that differ between the two types of radar systems (e.g., effective update rate and target resolution). Through these combinations of newly provided radar functions (enabled to some extent through upgrading) entirely new radar services—including multiple services—are made possible.

### Virtual Radar Services (Terminal and Long Range)

In this embodiment, a series of upgraded terminal radars are configured to emulate long-range radar systems in addition to providing regular terminal area surveillance.

The value of this approach is that some existing, older long range radar systems may then be decommissioned, or long range services may be provided in areas that need back up or additional coverage. The coverage requirements for the FAA's long range ARSR-4 radar as defined in Air Route Surveillance Radar Model 4 (ARSR-4) Operational Test and Evaluation (OT&E) Final Report, Thomas A. Healy, Raymond K. McDonald, Robert F. Pomrink, and William P. Conklin, DOT/FAA/CT-TN96/26, U.S. Department of Transportation, Federal Aviation Administration William J. Hughes Technical Center, incorporated herein by reference, are as follows:

“The coverage volume of the ARSR-4 extends from 5 to 250 nautical miles (nm) for 360° and from the radar line of site (RLS) to 100,000 feet above ground level (AGL) to 30° in elevation. A look-down beam detects targets to −7° below the radar horizon. The ARSR-4 must detect a 2.2 square meter radar cross section (RCS) target within this volume at any range less than 200 nm with a probability of 80 percent or greater.”

While some of these requirements are more difficult to achieve with an enhanced terminal radar (e.g., the look down mode and high siting to achieve −7° below the radar horizon) other requirements such as range, RCS and probability of detection should be more readily achievable. Indeed, some requirements are exceeded, such as the update rate. In any event, this embodiment of the invention provides a system and method offering regional coverage zones that emulate long range radar services.

In FIG. 12, the upgraded terminal radar 100 has received a new receiver, processor and transmitter upgrade, resulting in performance improvements to receiver sensitivity and transmitter efficiency. Assuming improvements on the order of 7 dB on the receive side and 2-3 dB on the transmit side, the upgrades present a margin of 9-10 dB over the previous older terminal radar. The existing radar data continues to be sent along a serial link to air traffic control 110, 180. The new data 120 includes 3-D height information, and as a result of the 9-10 dB improvement, improved range and smaller radar cross section tracking.

The additional radar data is then sent over Internet protocol 130 to a cloud-based data repository, where it is then available for merging with data from other similarly modified terminal radars 150. This process allows for the integration of 3-D extended range data to form a service that can then be used to emulate other virtual terminal radars 160 or long-range radars 170. This data can then be converted to emulate the serial output and fed to air traffic control 180.

Additional enhancements made possible by the invention are as follows:

True/Magnetic North. Current radar systems may be set to register radar surveillance against either true or magnetic north. In this implementation, in process 150, data may be presented in either format to the user depending on needs, i.e., one of the formats will be a virtual format.

Wide Area Multilateration (WAMLAT) Augmentation. Due to dilution of precision, WAMLAT accuracy degrades at the edges of coverage, usually around the locations of the WAMLAT sensors. This implementation offers 3-D data that can be used to enhance the overall surveillance solution accuracy and integrity. WAMLAT also relies on aircraft transponder replies which can be spoofed; however this enhancement provides a true 3-D primary radar picture.

Automatic Dependent Surveillance (ADS-B) Augmentation. ADS-B is also subject to spoofing, and this implementation can serve as a 3-D truth source or back up for the service.

Regional Real Time Drone Map. The ability of the enhanced radar to detect smaller targets, due to the 10 dB increase in overall sensitivity offers the ability to track even the smallest drones at long ranges and to provide a comprehensive 3-D drone picture for security and other applications.

1. A method of enhancing radar functionality in a geographical region wherein a plurality of existing terminal radar systems provide limited area surveillance, the method comprising the steps of:
selecting one of the terminal radar systems having an existing radar transmitter, radar receiver and processor that together provide only short-range, 2-D radar surveillance;
upgrading the existing radar transmitter with an improved transmitter having a higher efficiency, upgrading the existing radar receiver with an improved receiver having a higher sensitivity, and upgrading the existing processor with an improved processor operative to perform a new functions based upon the higher sensitivity and higher sensitivity;
wherein the new functions include the acquisition of additional surveillance data, extended surveillance range and improved target resolution; and
wherein the selected terminal radar system continues to provide short-range, 2-D surveillance in addition to the new functions.

2. The method of claim 1, wherein the new functions enable the selected terminal to provide long range, 3-D en route radar data including height information while continuing to provide short-range, 2-D surveillance data.

3. The method of claim 2, wherein the 3-D data is virtual 3-D data synthesized from the 2-D surveillance data.

4. The method of claim 2, wherein the additional surveillance data is used to track targets with extended ranges in 3-D.

5. The method of claim 1, wherein the upgraded terminal radar systems meet at least some Spectrum Efficient National Surveillance Radar (SENSR) requirements.

6. The method of claim 1, wherein the new functions include the ability to register radar surveillance against either true or magnetic north.

7. The method of claim 1, wherein the new functions provide a 3-D primary radar picture to augment Wide Area Multilateration (WAMLAT).

8. The method of claim 1, wherein the new functions serve as a 3-D truth source or back up service to augment Automatic Dependent Surveillance (ADS-B).

9. The method of claim 1, wherein the new functions provide a regional real-time drone map.
